(19) United States
(12) Patent Application Publication
(10) Pub. No.: US 2018/0156114 A1
(43) Pub. Date: Jun. 7, 2018

(54) BEARING FOR TURBINE ENGINES

(71) Applicant: GENERAL ELECTRIC COMPANY, Schenectady, NY (US)

(72) Inventor: Fabio Nonato de Paula, Niskayuna, NY (US)

(21) Appl. No.: 15/366,668

(22) Filed: Dec. 1, 2016

(51) Int. Cl. F02C 7/06; F16C 19/54; F16C 33/44; F16C 33/62; F16C 33/32; F02C 3/04; F02C 7/36; F04D 29/053; F04D 29/056; F01D 25/28; F01D 25/00

(52) U.S. Cl. CPC F02C 7/06; F16C 19/548; F16C 33/44; F16C 33/62; F16C 33/32; F02C 3/04; F05D 2240/50; F04D 29/053; F04D 29/056; F01D 25/28; F01D 25/005; F16C 2360/23; F05D 2220/32; F02C 7/36

(57) ABSTRACT

Embodiments of bearings for turbine engines are provided herein. In some embodiments, a fan shaft assembly for a turbine engine may include a fan shaft; a stationary support; and at least one bearing disposed between the stationary support and fan shaft, the at least one bearing comprising: an inner raceway; an outer raceway; a row of a plurality of spherical roller bearings disposed between the inner raceway and outer raceway; and a cage disposed between the inner raceway and outer raceway.

### BACKGROUND

The field of the disclosure relates generally to turbine engines, particularly, bearings for turbine engines, and more particularly, bearings for a fan shaft of a geared turbine engine.

Conventional geared engines typically utilize tapered roller bearings to support, and facilitate rotation of, a fan shaft. The tapered roller bearings utilized in conventional geared engines provide a combined load (e.g., axial and radial loads) capability that is sufficient to support the fan shaft during operation of the engine. However, tapered roller bearings suffer from high heat generation due to various points of contact between the tapered roller and surfaces of the cup and cone. Such high heat generation causes excess wear and premature failure of the bearings, and further, requires the use of more robust cooling system within the engine to dissipate and/or remove the heat from the bearings, thereby reducing the efficiency the engine. One way to reduce contact between the bearing rollers and raceways, and thus the generation of heat, is to utilize one or more ball bearings as thrust bearings in combination with cylindrical roller bearings to for radial support. However, the inventors have observed that use of a ball bearing requires a prohibitively large and heavy ball bearing. Moreover, the combination of ball bearings and cylindrical roller bearings increases a total number of bearings needed, thus adding complexity and weight to the engine with a possible reliability penalty.

Therefore, the inventors have provided an improved bearing for turbine engines.

### BRIEF DESCRIPTION

Embodiments of bearings for turbine engines are provided herein. In some embodiments, a fan shaft assembly for a turbine engine may include a fan shaft; a stationary support; and at least one bearing disposed between the stationary support, the at least one bearing comprising: an inner raceway; an outer raceway; a row of a plurality of spherical roller bearings disposed between the inner raceway and outer raceway; and a cage disposed between the inner raceway and outer raceway.

In some embodiments, a turbine engine may include a low pressure turbine shaft; a fan shaft; a gear box rotatably coupling the low pressure turbine shaft to the fan shaft; a fan shaft assembly, comprising: the fan shaft; a stationary support; and at least one bearing having an inner raceway, an outer raceway, a row of a plurality of spherical roller bearings disposed between the inner raceway and outer raceway, and a cage disposed between the inner raceway and outer raceway, the at least one bearing disposed between the stationary support and the fan shaft.

The foregoing and other features of embodiments of the present invention will be further understood with reference to the drawings and detailed description.

### DRAWINGS

These and other features, aspects, and advantages of the present disclosure will become better understood when the following detailed description is read with reference to the accompanying drawings in which like characters represent like parts throughout the drawings, wherein:

FIG. 1 is a partial schematic view of an engine;

FIG. 2 is a partial schematic of a fan shaft assembly;

FIG. 3 is a partial cross-sectional view of an exemplary tapered roller bearing;

FIG. 4 is a partial schematic of a fan shaft assembly in accordance with some embodiments of the present invention;

FIG. 5 is a partial cross-sectional view of an exemplary spherical roller bearing in accordance with some aspects of the present invention;

FIG. 6 is a partial schematic of a fan shaft assembly in accordance with some embodiments of the present invention;

FIG. 7 is a partial cross-sectional view of an exemplary spherical roller bearing in accordance with some aspects of the present invention.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

Embodiments of bearings for turbine engines are provided herein. In at least some embodiments, spherical roller bearings may be utilized to support a shaft of a fan shaft assembly. Such utilization of spherical roller bearings may advantageously provide sufficient moment, axial and radial stiffness to support the fan shaft while reducing an amount of heat produced as compared to conventionally utilized tapered roller bearings, thereby reducing wear and instances of breakdown. In addition, in at least some embodiments utilizing spherical roller bearings allows for a reduction in an overall number of bearings needed to support the fan shaft, as compared to other conventional configurations that utilize a combination of ball and roller bearings, thereby reducing an overall complexity and weight of the engine.

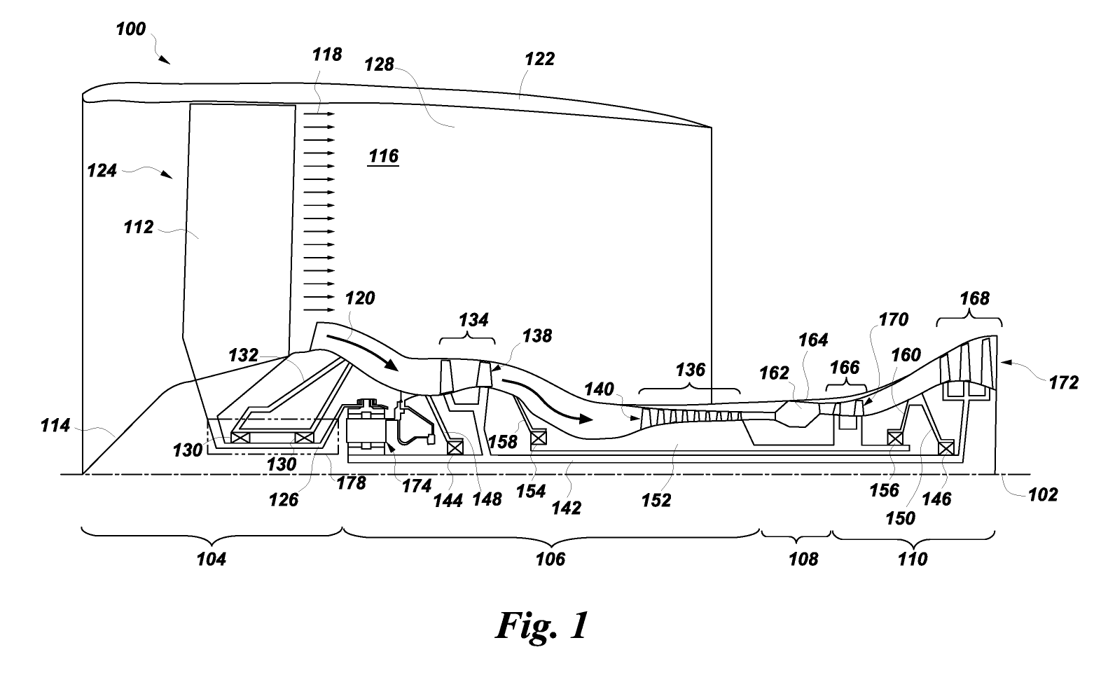

FIG. 1 is a partial cross sectional view of an engine 100. In the exemplary embodiment, the engine 100 is a gas turbine engine suitable for use in, for example, aviation or marine applications. Alternatively, the engine 100 may be any other turbine engine and/or turbomachine, including, without limitation, a steam turbine engine, a centrifugal compressor, and a turbocharger. Although only a portion is shown, it is to be understood that the engine 100 may be annular in form, for example about an axis 102. In some embodiments, the engine 100 may generally comprise an air intake section 104, compression section 106, combustion section 108 and turbine section 110.

The air intake section 104 generally comprises a fan 124 having a plurality of fan blades 112 coupled to a hub 114 and a fan shaft assembly 178 having a rotatable fan shaft 126. In some embodiments, a casing 122 may be disposed about the fan 124 and at least a portion of the engine 100, thereby forming a passage 116 for a flow of air (e.g., bypass air) driven by the fan 124, such as indicated by arrows 118. In such embodiments, the casing 122 may be at least partially supported by a plurality of struts (one strut 128 shown). In operation, the fan 124 draws air into the engine 100, directing at least a portion of the air through the passage 116 and at least a portion of the air into the compressor section 106.

The compression section 106 is mechanically and fluidly coupled to the fan section 104 and generally comprises one or more compressors, for example, such as a first compressor (low pressure compressor) 134 and second compressor 136 (high pressure compressor), as shown in the figure.

The first compressor 134 receives the directed air from the air intake section 104 and compresses the air via a plurality of compressor blades, vanes or stages (collectively shown at 138). In some embodiments, the compressor blades 138 may be coupled to a first shaft (low pressure turbine (LPT) shaft) 142 to drive rotation of the compressor blades 138. One or more bearings (a first, or forward end low pressure turbine bearing 144 and a second, or aft end low pressure turbine bearing 146 shown) may be disposed between one or more stationary supports 148, 150 and the LPT shaft 142 to facilitate rotation of the LPT shaft 142 and/or dampen vibrational energy imparted on the LPT shaft 142 during operation of the engine 100. The one or more bearings may be any type of bearings suitable for use within the engine 100, for example, such as gas bearings, journal bearings or the like.

The second compressor 136 receives the compressed air from the first compressor 134 and further compresses the air via a plurality of compressor blades or stages (collectively shown at 140). In some embodiments, the compressor blades 140 may be coupled to a high pressure turbine (HPT) shaft (core shaft) 152 to drive rotation of the compressor blades 140. One or more bearings (a third, or forward end high pressure turbine bearing, 154 and a fourth, or aft end high pressure turbine bearing 156 shown) may be disposed between one or more stationary supports 158, 160 and the HPT shaft 152 to facilitate rotation of the HPT shaft 152 and/or dampen vibrational energy imparted on the HPT shaft 152 during operation of the engine 100. The one or more bearings may be any type of bearings suitable for use within the engine 100, for example, such as gas bearings, journal bearings or the like.

Although only a limited number of compressors and limited number of stages for each compressor are shown in the figure, any number of compressors and/or compressor stages may be present to facilitate suitable operation of the engine 100 for a desired application.

The combustion section 108 receives the compressed air from the second compressor 136, mixes the compressed air with a fuel, and facilitates an ignition of the fuel/air mixture. The combustion section 108 generally includes a combustor 162 having a combustion chamber 164 mechanically and fluidly coupled to the compression section 106 and turbine section 110. The combustor 162 may be any type of suitable combustor known in the art and may include any components (e.g., cowls, swirlers, nozzles, igniters, fuel injectors, or the like) required to facilitate the ignition of the fuel/air mixture as described above.

The turbine section 110 is mechanically and fluidly coupled to the combustion section 108 and generally comprises one or more turbines, for example, such as a first turbine (high pressure turbine) 166 and second turbine (low pressure turbine) 168 as shown in the figure. Although only a limited number of turbines and limited number of stages for each turbine are shown in the figure, any number of turbines and/or turbine stages may be present to facilitate suitable operation of the engine 100 for a desired application.

In some embodiments, the first turbine 166 and second turbine 168 each may comprise a plurality of turbine blades and turbine nozzles, or stages (collectively shown at 170 and 172). With respect to the first turbine 166, the turbine blades 170 may be coupled to the HPT shaft 152, which is coupled to the second compressor 136, as described above. In operation of such embodiments, the first turbine 166 receives the heated air from the combustion section 108 and coverts at least a portion of the thermal energy (e.g., provided by ignition of the fuel/air mixture in the combustion chamber 164) into mechanical rotational energy via the plurality of turbine blades 170. The rotation of the turbine blades 170 causes the HPT shaft 152 to rotate, thereby causing the compressor blades 140 of the second compressor 136 to rotate.

With respect to the second turbine 168, the turbine blades 172 may be coupled to the LPT shaft 142, which is coupled to the first compressor 134, as described above. In some embodiments, the LPT shaft 142 may also be coupled to the fan shaft 126, for example, such as shown in FIG. 1. In operation, the second turbine 168 receives the heated air from the first turbine 166 and coverts at least another portion of the thermal energy into mechanical rotational energy via the plurality of turbine blades 172. The rotation of the turbine blades 172 causes the second shaft 142 and the fan shaft 126 to rotate, thereby causing the compressor blades 138 of the second compressor 134 and the fan 124 to rotate.

Although described above in the context of an engine having a two spool configuration (e.g., a high pressure (HP) spool comprising a HP turbine and HP compressor and low pressure (LP) spool comprising a LP turbine and LP compressor), it is to be understood that the engine may have a three spool configuration having an intermediate spool (e.g., an intermediate spool comprising an intermediate turbine and intermediate compressor).

The inventors have observed that in conventional engine configurations (e.g., such as shown in FIG. 1) separate components coupled to a common shaft may require different rotational speeds to perform a desired function. For example, the second turbine 168 may have a required rotational speed that is significantly higher that a required rotational speed of the fan 124. For example, in some embodiments, the second turbine 168 may have a rotational speed requirement of about 11,000 revolutions per minute (rpm) and the fan 124 may have a rotational speed requirement of about 2,400 to about 3000 rpm. To accommodate for this difference in speed, in some embodiments, a gear box 174 may be utilized to allow each of the components (e.g., the low pressure/second turbine 168 and fan 124) to operate at different speeds. In such embodiments, the gear box (power gear box (PGB)) 174 may couple the LPT shaft 142 to the fan shaft 126, for example, such as shown in FIG. 1. The gear box 174 may be any type of gear box suitable to facilitate coupling the LPT shaft 142 to the fan shaft 126 while allowing each of the second turbine 168 and fan 124 to operate at a desired speed. For example, in some embodiments, the gear box 174 may be a reduction gearbox. Utilizing a reduction gear box may enable the comparatively higher speed operation of the second turbine 168 while maintaining fan speeds sufficient to provide for increased air bypass ratios, thereby allowing for efficient operation of the engine 100. Moreover, utilizing a reduction gear box may allow for a reduction in turbine stages that would otherwise be present (e.g., in direct drive engine configurations), thereby providing a reduction in weight and complexity of the engine.

In such geared configurations, the fan shaft assembly 178 may include bearings 130 disposed between a stationary support 132 and the fan shaft 126. When present, the bearings 130 may provide support to the fan shaft 126 such that the fan shaft 126 has a desired stiffness, facilitate rotation of the fan shaft 126 and/or dampen vibrational energy imparted on the fan shaft 126 during operation of the engine 100.

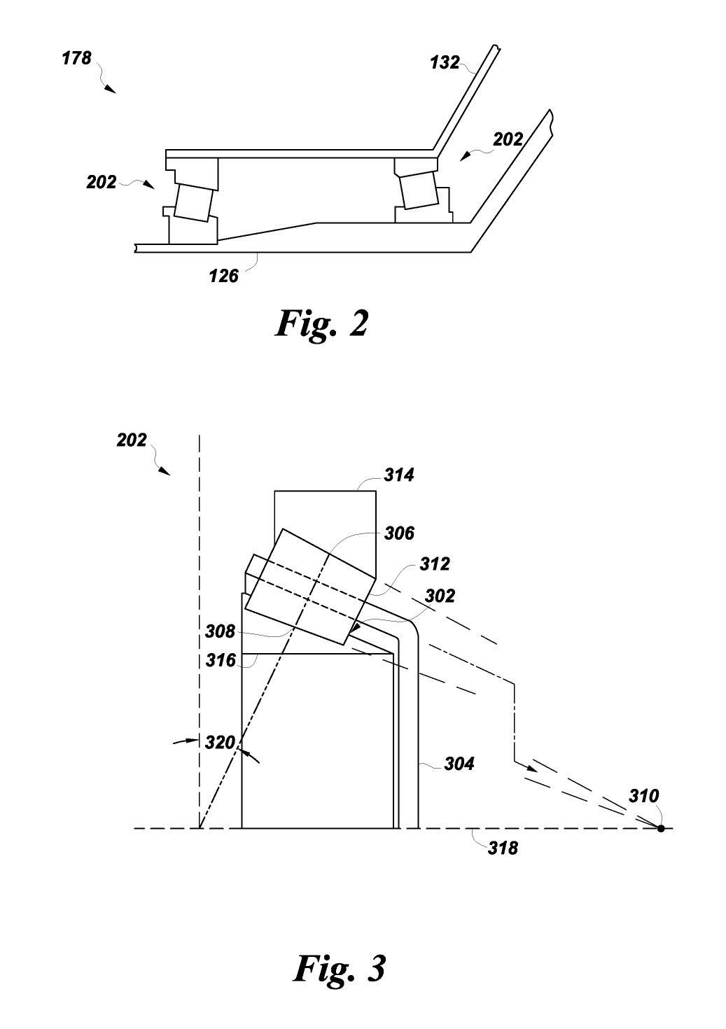

Conventional geared engines typically utilize tapered roller bearings 202 disposed proximate opposing ends of the fan shaft 126 in a back-to-back arrangement, for example, such as shown in FIG. 2. Referring to FIG. 3, each of the tapered roller bearings 202 have a cup (outer raceway) 314, cone (inner raceway) 316, a plurality of tapered rollers (one shown) 312 disposed between the cup 314 and cone 316, and a cage 304. The plurality of tapered rollers (one shown) 312, cup 314 and cone 316 are each tapered in such a manner that the tapered surfaces converge towards a common point 310 on an axis 318 of the bearing 202. In addition, the plurality of tapered rollers (one shown) 312, cup 314 and cone 316 may be configured to provide a desired amount of capacity with respect to thrust and radial loading. For example, an angle 320 (e.g., a contact angle) formed by a line joining points of contact between the plurality of tapered rollers 312 and raceways 314, 316) and a line 322 perpendicular to the axis 318 of the bearing 202 may be varied in accordance with a desired performance of the bearing 202. For example, as the angle 320 increases the thrust load capability of the bearing 202 increases while the radial load capability decreases. Conversely, as the angle 320 decreases the thrust load capability of the bearing 202 decreases while the radial load capability increases.

The tapered roller bearings utilized in conventional geared engines provide a combined load (e.g., axial and radial loads) capability that is sufficient to support the fan shaft during operation of the engine. However, such tapered roller bearings suffer from high heat generation due to various points of contact between the tapered roller and surfaces of the cup and cone. For example, as shown in FIG. 3, heat may be generated at line contact points between the tapered roller 312 and the inner surface 306 of the cup 314 and an outer surface 308 of the cone 316 and at axial points of contact between the shoulders of the tapered roller 312 and the cone 316 (shown at 302).

The above described high heat generation causes excess wear and premature failure of the bearings, and further, requires the use of more robust cooling system within the engine to dissipate and/or remove the heat from the bearings, thereby reducing the efficiency the engine. One way to reduce contact between the bearing rollers and raceways, and thus the generation of heat, is to utilize one or more ball bearings as thrust bearings in combination with cylindrical roller bearings for radial support. However, the inventors have observed that use of a ball bearing requires a excessively large and heavy ball bearing. Moreover, the combination of ball bearings and cylindrical roller bearings increases a total number of bearings needed, thus adding complexity and weight to the engine.

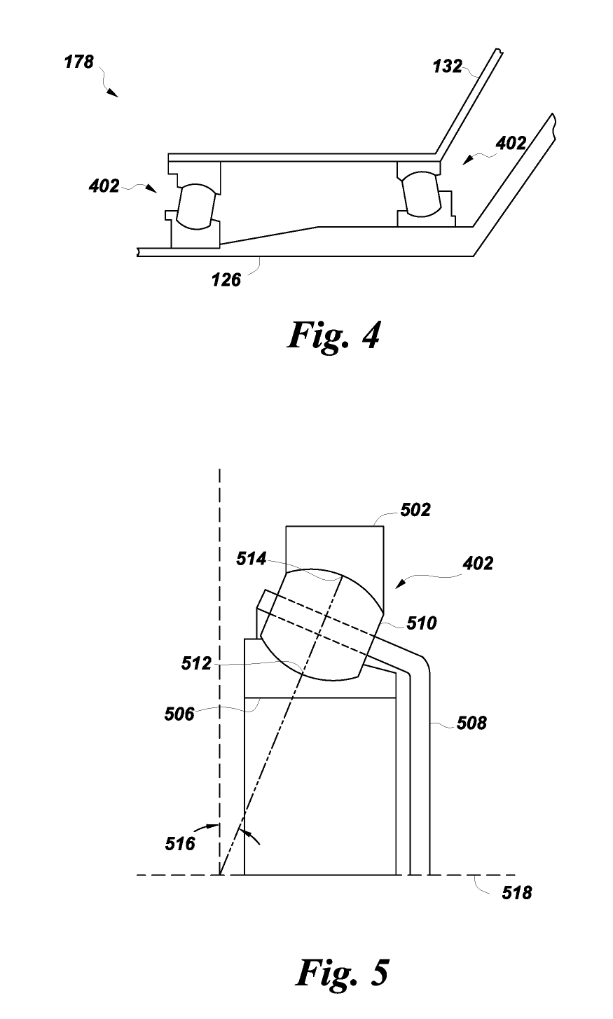

As such, referring to FIG. 4, in some embodiments, the fan shaft assembly 178 may comprise at least one spherical roller bearing (two spherical roller bearings 402 shown) disposed between the stationary support 132 and the fan shaft 126. The inventors have observed that, due to the thrust, radial and moment load handling capabilities of spherical roller bearing assemblies, utilizing a spherical roller bearing within the fan shaft assembly 178 allows for a reduction in the number of bearings used, as compared to conventional configurations that utilize a combination of ball bearings and cylindrical roller bearings, thereby reducing weight and complexity of the engine. Although shown as disposed on opposing ends of the fan shaft 126 in the figure, the at least one spherical roller bearing 402 may be disposed at any location across the span or length of the fans shaft 126 suitable to provide a desired amount of support to the fan shaft 126.

The at least one spherical roller bearing (spherical roller bearing) 402 may be configured in any manner suitable to support the fan shaft 126. For example, referring to FIG. 5, each of the spherical roller bearings 402 may have outer raceway 502, inner raceway 506, a plurality of spherical rollers (one spherical roller shown) 510 disposed between the outer raceway 502 and inner raceway 506, and a cage 508.

The inventors have observed that the spherical shape of the rollers 510 of the spherical roller bearing 402 provides a smaller area of contact (points of contact shown at 512 and 514) between the spherical rollers 510 and raceways 502, 506 as compared to roller or tapered roller bearings (e.g., as described above). Such a reduction of contact area reduces an amount of heat generated by the bearing during use. As such, utilizing the spherical roller bearing 402 in the fan shaft assembly 178 instead of the conventionally utilized tapered roller bearings allows for the fan shaft to be suitably supported while generating less heat. Generating less heat reduces load on the engine cooling systems and reduces wear that would otherwise be present in instances of higher heat generation.

In some embodiments, the at least one spherical roller bearing 402 may be configured to provide a desired amount of capacity with respect to thrust and radial loading. For example, an angle 516 (e.g., a contact angle) formed by a line joining the points of contact 512, 514 between the plurality of spherical rollers 510 and raceways 502, 506) and a line 520 perpendicular to the axis 518 of the bearing 402 may be varied in accordance with a desired performance of the bearing 402.

For example, as the angle 516 increases the thrust load capability of the bearing 402 increases while the radial load capability decreases. Conversely, as the angle 516 decreases the thrust load capability of the bearing 402 decreases while the radial load capability increases. The angle 516 may be any angle suitable to provide a desired thrust load and radial load capability. For example, in some embodiments, the angle 516 may be about 10 to about 65 degrees.

Each of the components of the spherical roller bearing 402 may be fabricated from any compatible material suitable to withstand the loads applied during operation while minimizing friction between the bearing components. For example, in some embodiments, the cage 508 may be fabricated from polymers, metals (e.g., alloys such as a steel alloy, chrome steel, stainless steel, or the like), or the like. In some embodiments, the plurality of spherical rollers 510 may be fabricated from a metal (e.g., (e.g., alloys such as a steel alloy, chrome steel, stainless steel, or the like), a ceramic (e.g., silicon nitride), or the like. In some embodiments, the raceways may be fabricated from a metal (e.g., (e.g., alloys such as a steel alloy, chrome steel, stainless steel, or the like), a ceramic (e.g., silicon nitride), or the like.

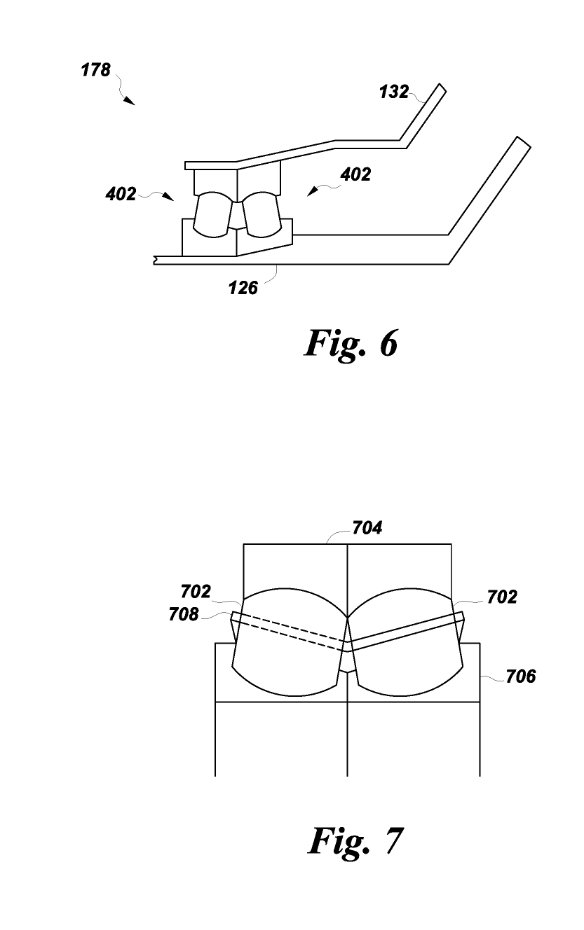

Although shown in FIG. 4 as being two separate spherical roller bearings 402 each having a single row of spherical rollers, in some embodiments the at least one spherical roller bearing may comprise a single roller bearing having two or more rows of spherical rollers, for example such as shown in FIG. 6. When present, the roller bearing having two or more rows of spherical rollers may be disposed at any position across the span of length of the fan shaft 126 suitable to provide a desired amount of support to the fan shaft 126.

In embodiments where the roller bearing having two or more rows of spherical rollers the spherical roller bearing 402 may comprise a plurality of rows (two rows of spherical roller bearings shown at 702) disposed between a common outer raceway 704 and common inner raceway 506 and held in position via a common cage 708. In such embodiments, each component of the spherical roller bearing 402 (e.g., cup, cone, spherical roller bearing, etc) may similar or the same in configuration, materials, or the like, as any of the embodiments described above with respect to the corresponding components.

Thus, embodiments of roller bearings for turbine engines have been provided herein. Ranges disclosed herein are inclusive and combinable (e.g., ranges of “about 2 mils and about 100 mils”, is inclusive of the endpoints and all intermediate values of the ranges of “about 2 mils and about 100 mils,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “some embodiments”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A fan shaft assembly for a turbine engine, comprising:
a fan shaft;
a stationary support; and
at least one bearing disposed between the stationary support and the fan shaft, the at least one bearing comprising:
an inner raceway;
an outer raceway;
a plurality of spherical roller bearings disposed between the inner raceway and outer raceway; and
a cage disposed between the inner raceway and outer raceway.

2. The fan shaft assembly wherein the at least one bearing comprises two bearings disposed proximate opposing ends of the fan shaft.

3. The fan shaft assembly of claim 1, wherein the at least one bearing comprises:
a plurality of rows of the plurality of spherical roller bearings disposed between the inner raceway and the outer raceway.

4. The fan shaft assembly of claim 1, wherein the cage is fabricated from a polymer or metal.

5. The fan shaft assembly of claim 1, wherein the plurality of spherical roller bearings are fabricated from a metal or a ceramic.

6. The fan shaft assembly of claim 1, wherein the inner raceway and outer raceway are fabricated from a metal or a ceramic.

7. The fan shaft assembly of claim 1, wherein an angle formed by a line joining points of contact between the plurality of spherical roller bearings and the inner raceway and the outer raceway and a line perpendicular to an axis of the bearing is about 10 to about 65 degrees.

8. A turbine engine, comprising:
a low pressure turbine shaft;
a fan shaft;
a gear box rotatably coupling the low pressure turbine shaft to the fan shaft;
a fan shaft assembly, comprising:
the fan shaft;
a stationary support; and
at least one bearing having an inner raceway, an outer raceway, a plurality of spherical roller bearings disposed between the inner raceway and outer raceway, and a cage disposed between the inner raceway and outer raceway, the at least one bearing disposed between the stationary support and the fan shaft.

9. The turbine engine of claim 8, wherein the at least one bearing comprises two bearings disposed proximate opposing ends of the fan shaft.

10. The turbine engine of claim 8, wherein the at least one bearing comprises:
a plurality of rows of the plurality of spherical roller bearings disposed between the inner raceway and the outer raceway.

11. The turbine engine of claim 8, wherein the cage is fabricated from a polymer or metal.

12. The turbine engine of claim 8, wherein the plurality of spherical roller bearings are fabricated from a metal or a ceramic.

13. The turbine engine of claim 8, wherein the inner raceway and outer raceway are fabricated from a metal or a ceramic.

14. The turbine engine of claim 8, wherein an angle formed by a line joining points of contact between the plurality of spherical roller bearings and the inner raceway and the outer raceway and a line perpendicular to an axis of the bearing is about 10 to about 60 degrees.
